(19) United States
(12) Patent Application Publication
(10) Pub. No.: US 2021/0048813 A1
(43) Pub. Date: Feb. 18, 2021

(54) LOAD CONTROL METHODS, MOBILE PLATFORMS, AND COMPUTER-READABLE STORAGE MEDIA

(71) Applicant: SZ DJI TECHNOLOGY CO., LTD., Shenzhen (CN)

(72) Inventors: Changxin HE, Shenzhen (CN); Yong YANG, Shenzhen (CN)

(73) Assignee: SZ DJI TECHNOLOGY CO., LTD., Shenzhen (CN)

(21) Appl. No.: 17/084,631

(22) Filed: Oct. 30, 2020

Related U.S. Application Data
(63) Continuation of application No. PCT/CN2018/119225, filed on Dec. 4, 2018.

(51) Int. Cl. G05D 1/00; B64C 39/02; G06F 13/42

(52) U.S. Cl. CPC G05D 1/0022; B64C 39/024; G06F 2213/0042; B64C 2201/12; G06F 13/4282

(57) ABSTRACT

The present disclosure provides load control methods, mobile platforms, and computer-readable storage media. The load control method includes: receiving a control instruction including original identification information of a load from a control device corresponding to the mobile platform; determining, based on the original identification information, a target hardware port of the mobile platform connected to the load from a plurality of hardware ports of the mobile platform; modifying the original identification information to target identification information identifiable by the target hardware port; and sending the modified control instruction to the load through the target hardware port. The mobile platform includes: a body; a power system mounted in the body to supply power; a plurality of hardware ports each configured to connect to a load; a communication interface to communicate with a control device corresponding to the mobile platform; and one or more processors to perform the load control method.

### RELATED APPLICATIONS

The present patent document is a continuation of PCT Application Serial No. PCT/CN2018/119225, filed on Dec. 4, 2018, designating the United States and published in Chinese, which is hereby incorporated by reference.

### BACKGROUND

### 1. Technical Field

The present disclosure relates to the technical field of unmanned aerial vehicles, and in particular, to a load control method, a movable platform, and a computer-readable storage medium.

### 2. Background Information

In the conventional techniques, an unmanned aerial vehicle carries a load, and the load may include at least one of the following devices: a gimbal, a camera, and a gimbal electronic speed control.

To meet application requirements, the unmanned aerial vehicle may need to carry a plurality of loads, where the loads are connected to the unmanned aerial vehicle by using different hardware ports, and the unmanned aerial vehicle may distinguish the plurality of loads by using different hardware ports. Therefore, the mounting positions of the plurality of loads are limited. When the mounting positions of the plurality of loads are changed, the unmanned aerial vehicle may be unable to correctly distinguish different loads, and the scalability of the unmanned aerial vehicle is limited.

### BRIEF SUMMARY

This Summary is provided to introduce a selection of implementations in a simplified form that are further described below in the Detailed Description. This Summary is not intended to identify all features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Exemplary embodiments of the present disclosure provide a load control method, a mobile platform, and a computer-readable storage medium, to realize the real-time, stable, and reliable switching and control of the mobile platform and multiple loads carried thereon, and improve the scalability of the mobile platform.

The first aspect of the exemplary embodiments of the present disclosure provides a load control method for a mobile platform. The method may comprise: receiving, from a control device corresponding to the mobile platform, a control instruction including original identification information of a load; determining, based on the original identification information, a target hardware port of the mobile platform connected to the load from a plurality of hardware ports of the mobile platform; modifying, based on the target hardware port, the original identification information in the control instruction to target identification information identifiable by the target hardware port; and sending the modified control instruction to the load through the target hardware port.

The second aspect of the exemplary embodiments of the present disclosure provides a mobile platform. The mobile platform may comprise: a body; a power system mounted in the body and configured to supply power; a plurality of hardware ports each configured to connect to a load; a communication interface configured to communicate with a control device corresponding to the mobile platform; and one or more processors configured to: receive a control instruction from the control device through the communication interface, wherein the control instruction includes original identification information of a load; determine, based on the original identification information, a target hardware port of the mobile platform connected to the load from the plurality of hardware ports; modify the original identification information in the control instruction to target identification information identifiable by the target hardware port; and send the modified control instruction to the load through the target hardware port.

By receiving a control instruction sent by a control device corresponding to the mobile platform, where the control instruction includes original identification information of a load; determining, based on the original identification information of the load, a hardware port connected to the load; modifying, based on the determined hardware port connected to the load, the original identification information of the load in the control instruction to target identification information identifiable by the hardware port; and sending the modified control instruction to the load through the hardware port, the load control method, mobile platform, and computer-readable storage media provided in the exemplary embodiments of the present disclosure can realize real-time, stable, and reliable switching and control for a plurality of loads carried by the mobile platform, and improve the scalability of the mobile platform. If a device needs to be added at a hardware port or a hardware port needs to be directly added in the future, only original identification information of a load and target identification information identifiable by the hardware port needs to be configured. Therefore, software changes are reduced, an increase of the quantity of loads does not cause instability or brings about limitations, and development and maintenance costs are reduced.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show some embodiments of the present disclosure, and persons of ordinary skill in the art may still derive other drawings from these accompanying drawings without creative efforts.

FIG. 1 is a flowchart of a load control method according to some exemplary embodiments of the present disclosure;

FIG. 2 is a flowchart of a load control method according to some exemplary embodiments of the present disclosure;

FIG. 3 is a flowchart of a load control method according to some exemplary embodiments of the present disclosure;

FIG. 4 is a structural diagram of a mobile platform according to some exemplary embodiments of the present disclosure; and

FIG. 5 is a structural diagram of a mobile platform according to some exemplary embodiments of the present disclosure.

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprises”, “comprising”, “includes” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

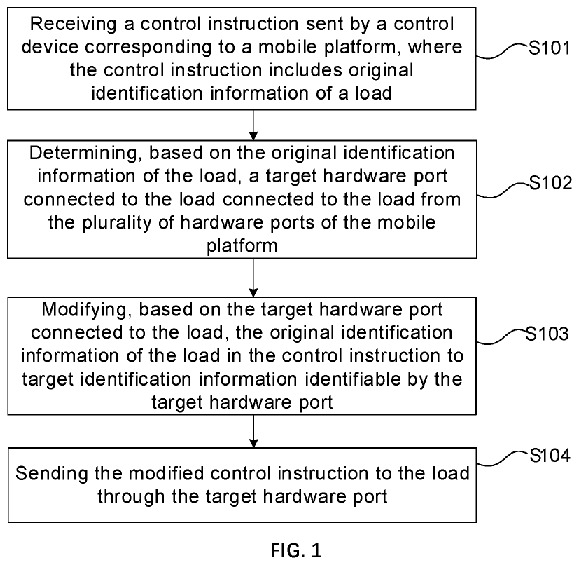

FIG. 1 is a flowchart of a load control method according to some exemplary embodiments of the present disclosure. As shown in FIG. 1, the method in some exemplary embodiments is applicable to a mobile platform. The mobile platform may include but is not limited to an unmanned aerial vehicle. The mobile platform may include a plurality of hardware ports, and the hardware ports may be configured to connect to loads. A load may include but is not limited to at least one of the following devices: a gimbal, a photographing device, and a gimbal electronic speed control. The method in some exemplary embodiments may be performed by the mobile platform. The method may include the following steps.

Step S101: receiving a control instruction sent by a control device corresponding to a mobile platform, where the control instruction includes original identification information of a load.

In an exemplary embodiment, the control device corresponding to the mobile platform may be a remote control configured to control the mobile platform or may be a terrestrial maintenance base station for the mobile platform. In addition, in some exemplary embodiments, the control device may also be at least one of the following: a headset display (Virtual Reality (VR) glasses, a VR helmet, or the like), a mobile phone, a smart band, a tablet, or the like.

In an exemplary embodiment, the mobile platform may receive, through a communications apparatus, a control instruction sent by the control device, where the control instruction includes original identification information of a load, and the original identification information of the load is relative to the following modified target identification information. Original identification information of loads may be used to distinguish control instructions sent to the mobile platform when the control device needs to control different target loads. For example, original identification information included in a control instruction sent to a first load may be different from original identification information included in a control instruction sent to a second load. The control instruction in some exemplary embodiments some exemplary embodiments may include but not limited to a control instruction for gimbal posture, a control instruction for gimbal electronic speed control, photographing device parameter settings, an instruction for obtaining image data of a photographing device, and the like. The communications apparatus of the mobile platform in some exemplary embodiments some exemplary embodiments may include a wireless communications apparatus or may include a wired communications apparatus.

Step S102: determining, based on the original identification information of the load, a hardware port of the mobile platform connected to the load from the plurality of hardware ports of the mobile platform. The determined or selected hardware ports may also be called as target hardware port.

In an exemplary embodiment, because the mobile platform includes a plurality of hardware ports, and different hardware ports may be connected to different loads, to enable the control instruction sent by the control device to arrive at the corresponding load, the target hardware port connected to the load may need to be determined based on the original identification information of the load included in the control instruction. In an exemplary embodiment, the mobile platform may obtain in advance the correspondence between the original identification information of the load and the target hardware port connected to the load, and therefore determine, based on the correspondence, the target hardware port connected to the load.

Step S103: modifying, based on the target hardware port connected to the load, the original identification information of the load in the control instruction to target identification information identifiable by the target hardware port.

In an exemplary embodiment, the same load may be able to connect to different hardware ports. Therefore, to enable the load to identify the control instruction of the control device and avoid that when the same load is connected to a different hardware port, the load needs to adapt to control instructions including original identification information of the different load. Therefore, target identification information of data transmitted between the load and the target hardware port may be preconfigured. For example, the load can only identify an instruction including the target identification information. For example, a gimbal may only identify a control instruction including first target identification information, a photographing device may only identify a control instruction including second target identification information, and a gimbal electronic speed control may only identify a control instruction including third target identification information.

In an exemplary embodiment, after the target hardware port connected to the load is determined based on the original identification information of the load in the control instruction, the original identification information of the load in the control instruction may be modified to the target identification information identifiable by the target hardware port.

For example, if the control device wants to control a first gimbal at a first target hardware port, the control instruction may include original identification information “0101”. In this case, the mobile platform may determine, based on the original identification information “0101”, that the first load is connected to the first target hardware port, and then modify the original identification information “0101” in the control instruction to target identification information “0001” identifiable by the target hardware port, and then send, through the first target hardware port, the modified control instruction to the load connected to the first target hardware port. After receiving the modified control instruction, the first gimbal may execute the modified control instruction based on the target identification information “0001”. If the control device wants to control a second gimbal at a second target hardware port, the control instruction may include original identification information “0201”. In this case, the mobile platform may determine, based on the original identification information “0201”, that the second load is connected to the second target hardware port, and then modify the original identification information “0201” in the control instruction to target identification information “0001” identifiable by the target hardware port, and then send, through the second target hardware port, the modified control instruction to the load connected to the second target hardware port. After receiving the modified control instruction, the second gimbal may execute the modified control instruction based on the target identification information “0001”. Control processes of the photographing device and the gimbal electronic speed control may be the same as above and may not be described again herein.

Step S104: sending the modified control instruction to the load through the target hardware port.

In an exemplary embodiment, if the load receives the modified control instruction, a corresponding operation may be performed based on the control instruction, so that the load is controlled.

The load control method provided in some exemplary embodiments some exemplary embodiments may include: receiving a control instruction sent by a control device corresponding to the mobile platform, where the control instruction includes original identification information of a load; determining, based on the original identification information of the load, a target hardware port connected to the load; modifying, based on the target hardware port connected to the load, the original identification information of the load in the control instruction to target identification information identifiable by the target hardware port; and sending the modified control instruction to the load through the target hardware port. In an exemplary embodiment, for a plurality of loads carried by the mobile platform, real-time, stable, and reliable switching and control can be realized, and the scalability of the mobile platform is improved. If a device needs to be added at a hardware port or a hardware port needs to be directly added later on, only original identification information of a load and target identification information identifiable by the hardware port needs to be configured. Therefore, software changes may be reduced, an increase of the quantity of load does not cause instability or brings about limitations, and development and maintenance costs may be reduced.

On the basis of any one of the foregoing exemplary embodiments, if the control device wants to control linkage of the plurality of loads, the control instruction sent to the mobile platform may include original identification information of the plurality of loads; and the mobile platform may determine, based on the original identification information of the plurality of loads, a target hardware port connected to each load, modify original identification information of each load in the control instruction to target identification information identifiable by each target hardware port, and then send the modified control instruction to the load through each target hardware port. In this way, the linkage of the plurality of loads may be achieved.

On the basis of any one of the foregoing exemplary embodiments, the load may include at least one of a plurality of devices of different types, which may include the following devices: a gimbal, a photographing device, and a gimbal electronic speed control.

The target hardware port may be configured to connect to the load, that is, the target hardware port may be communicatively connected to each of the plurality of device, respectively.

For example, if the first load connected to the first target hardware port includes a gimbal and a photographing device, the first target hardware port may be communicatively connected to the gimbal and the photographing device in the first load, respectively; if the second load connected to the second target hardware port includes a gimbal, a photographing device, and a gimbal electronic speed control, the second target hardware port may be communicatively connected to the gimbal, the photographing device, and the gimbal electronic speed control in the second load, respectively. In an exemplary embodiment, the target hardware port may be communicatively connected to each device through a CAN (Controller Area Network) bus. In some exemplary embodiments, the target hardware port may be connected in other communication connection manners. For example, the first target hardware port may be connected to each device in the first load through a first CAN bus, and the second target hardware port may be connected to each device in the second load through a second CAN bus.

On the basis of any one of the foregoing exemplary embodiments, a link identification of a communication link between the target hardware port and each device may be different from a link identification of a communication link between the target hardware port and another device.

In an exemplary embodiment, because the same target hardware port is connected to different devices, to avoid data confusion, different link identifications may be configured for the communication links between the target hardware port and the devices. For example, if the target hardware port is communicatively connected to each device through a CAN bus, a CAN_ID may be configured for each link. Therefore, the control instruction may arrive at a corresponding device quickly and accurately. In addition, a data sender may be checked based on the CAN_ID or another check field, to ensure the security and reliability of transmitted data.

On the basis of any one of the foregoing exemplary embodiments, the devices of the same type may have the same target identification information. For example, target identification information of the gimbal may be “0001”; target identification information of the photographing device may be “0002”; and target identification information of the gimbal electronic speed control may be “0003”. When a hardware port needs to be added, target identification information of each device does not need to be reconfigured. Therefore, development and maintenance costs may be reduced.

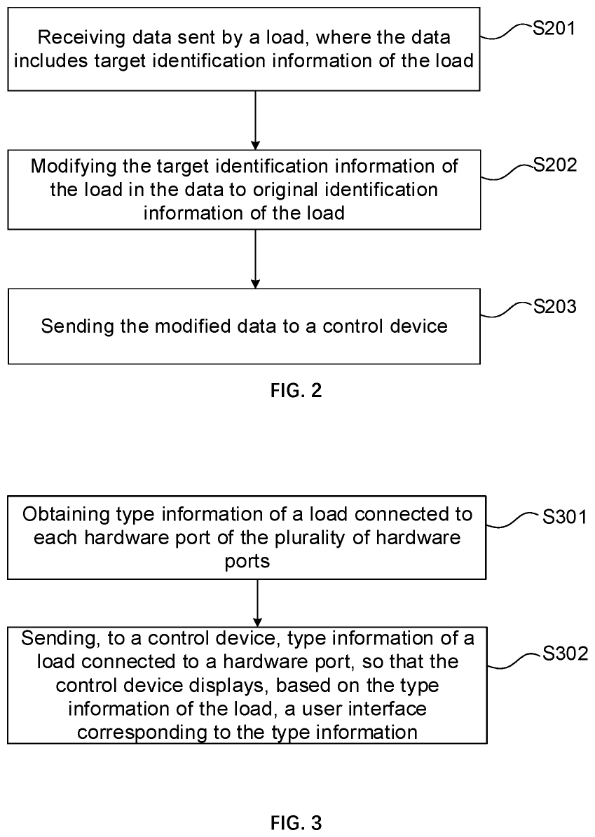

FIG. 2 is a flowchart of a load control method according to some exemplary embodiments of the present disclosure. As shown in FIG. 2, on the basis of the exemplary embodiment shown in FIG. 1, the method in some exemplary embodiments some exemplary embodiments may include the following steps.

Step S201: receiving data sent by the load, where the data includes the target identification information of the load.

In an exemplary embodiment, when the load needs to send the data to the control device, the data may carry the target identification information of the load and may be sent to the mobile platform through the target hardware port connected to the load.

Step S202: modifying the target identification information of the load in the data to the original identification information of the load.

In an exemplary embodiment, because the data sent by the load carries only the target identification information, if the data is directly sent to the control device, the control device may not know which load sends the data. Therefore, the mobile platform may need to modify the target identification information of the load in the data to the original identification information of the load that can be identified by the control device. In an exemplary embodiment, the mobile platform may receive, through the target hardware port, the data sent by the load. Therefore, the target identification information of the load may be modified to the original identification information of the load based on the target hardware port receiving the data.

Step S203: sending the modified data to the control device.

In an exemplary embodiment, after the data is modified, the mobile platform may send the modified data to the control device through the communications apparatus. In this way, the data may be sent by the load to the control device, and the control device may identify, based on the original identification information of the load in real time, stably, and reliably, the load sending the data.

FIG. 3 is a flowchart of a load control method according to some exemplary embodiments of the present disclosure. As shown in FIG. 3, on the basis of the exemplary embodiment shown in FIG. 1, before receiving a control instruction sent by a control device corresponding to the mobile platform, the method in some exemplary embodiments may include the following steps.

Step S301: obtaining type information of a load connected to each hardware port of the plurality of hardware ports.

In an exemplary embodiment, when the load is connected to the mobile platform, that is, the load may be connected to the hardware port of the mobile platform, the type information of the load connected to each hardware port of the plurality of hardware ports may be first obtained. The mobile platform may send a load type request to each hardware port. After receiving the load type request, the load may return its load type information to the mobile platform through the hardware port. In this way, the mobile platform may obtain a type of the load connected to each hardware port. In addition, the load at each hardware port may actively send the type information to the mobile platform. For example, the load may be connected to the hardware port, and may actively send the type information to the mobile platform after power-on. Further, before obtaining the load type information, the mobile platform may further detect whether the load is connected successfully.

Step S302: sending the type information of the load connected to the hardware port to the control device, so that the control device displays, based on the type information of the load, a user interface corresponding to the type information.

In an exemplary embodiment, after obtaining the type information of the load connected to the hardware port, the mobile platform may send the type information of the load to the control device. Because function control and buttons of different loads are different, the control device may perform switching and adaptation on user interfaces based on the type information of the load. For example, a photographing device of a first type may have a tap zoom function, but may not have a picture fusion function; and a photographing device of a second type may have a picture fusion function, but may not have a tap zoom function. Therefore, user interfaces corresponding to the two load types may be different. Further, the control device may configure different user interfaces based on different hardware ports and may control each device at a corresponding hardware port on each user interface. For example, when a user performs an operation on a first user interface, a control instruction for a device at the first port may be sent to the mobile platform and may carry corresponding original identification information.

On the basis of the foregoing exemplary embodiment, the original identification information of the load may be used to identify the type information of the load.

In an exemplary embodiment, the original identification information of the load may be used to distinguish the type information of the load. For example, original identification information of a gimbal of a first type may be “0101”, and original identification information of a gimbal of a second type may be “0102”. When obtaining the type information of the load, the mobile platform may configure the original identification information of the load based on different type information.

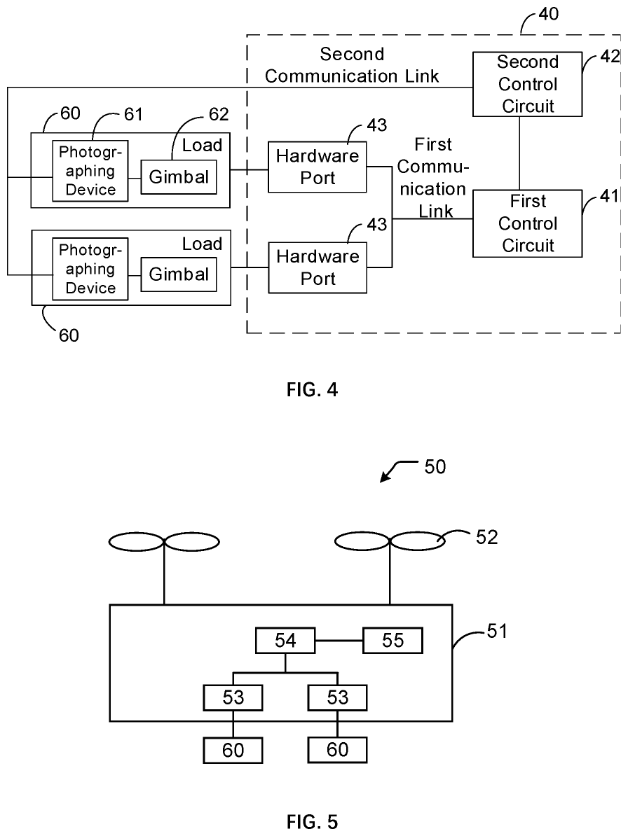

FIG. 4 is a structural diagram of a mobile platform according to some exemplary embodiments some exemplary embodiments of the present disclosure. As shown in FIG. 4, on the basis of the foregoing exemplary embodiment, the mobile platform 40 may include a first control circuit 41 and a second control circuit 42, and the first control circuit 41 may be communicatively connected to the second control circuit 42; the first control circuit 41 may be communicatively connected to the plurality of hardware ports 43, forming a first communication link; and the second control circuit 42 may be configured to communicatively connect to the photographing device 61, thereby forming a second communication link.

In an exemplary embodiment, the second communication link may be a USB interface communication link. Because the second communication link is connected to the photographing device 61, the photographing device 61 may transmit image data and download photographing device upgrade data through the second communication link. For example, the second communication link may be configured to transmit at least one of the following data: image data and photographing device upgrade data. In addition, in an exemplary embodiment, the first communication link may be a serial port communication link. The first communication link may be configured to transmit at least one of the following data: a control instruction and gimbal upgrade data. It should be noted that the image data and the photographing device upgrade data may not be transmitted through the first communication link because amounts of the image data and the photographing device upgrade data are far greater than the amounts of the control instruction and the gimbal upgrade data. If transmitted through the first communication link, the image data and the photographing device upgrade data may occupy a large bandwidth, thereby causing congestion of the first communication link, and consequently, the control instruction may not be transmitted normally. However, the gimbal upgrade data is small, and will not cause congestion of the first communication link. It should be noted that, types of the first communication link and the second communication link are not limited to the foregoing examples either. Likewise, data transmitted on each communication link is not limited to the foregoing examples either. In addition, the second communication link may not be limited to being connected to the photographing device either, but may also be connected to other devices.

For example, on the basis of the foregoing exemplary embodiment, the method in some exemplary embodiments some exemplary embodiments may include the following steps: when receiving second data of the photographing device 61 that is sent by the control device, the second control circuit 42 sends the second data to the photographing device 61 through the second communication link; and when receiving first data of the gimbal 62 that is sent by the control device, the second control circuit 42 sends the first data to the gimbal 62 through the first communication link.

In an exemplary embodiment, for example, the second data may be the photographing device upgrade data, and the first data may be the control instruction or the gimbal upgrade data. When receiving the second data sent by the control device, the second control circuit 42 may send the second data to the photographing device 61 through the second communication link. For example, the second data may include type information of the photographing device 61. Before receiving the second data, the photographing device 61 may determine whether the type information matches; and if the type information matches, continue to receive the second data, and further perform a corresponding operation based on the second data, for example, upgrade the firmware of the photographing device 61 based on the second data. When the second control circuit 42 receives the first data, the second control circuit 42 may send the first data to the gimbal 62 through the first communication link. If the first data is a control instruction for the photographing device 61, the gimbal 62 may transparently transmit the control instruction to the photographing device 61, or the control instruction for the photographing device 61 may be directly sent to the photographing device 61 through the first communication link. If the first data is a control instruction for the gimbal 62 or upgrade data for the gimbal, the first data may be directly sent to the gimbal 62 through the first communication link, and the gimbal 62 may perform a corresponding operation.

In the foregoing exemplary embodiment, the second control circuit 42 may be configured to receive the first data or the second data sent by the control device. Therefore, the second control circuit 42 may include a wireless communication circuit configured to establish a wireless communication connection to the control device. In some exemplary embodiments, the second control circuit 42 may also include a wired communication circuit. For example, the upgrade data of the photographing device or the upgrade data of the gimbal 62 may be transmitted by the control device (such as a PC) through the wired communication circuit. In some exemplary embodiments, because the first control circuit 41 is communicatively connected to the second control circuit 42, a wireless communication circuit may also be disposed in the first control circuit 41.

In the foregoing exemplary embodiment, after receiving the data sent by the control device, the second control circuit 42 may determine whether the data is the first data or the second data, and therefore select different communication links. Therefore, the second control circuit 42 may include a routing circuit configured to forward communication signals, so that the communication signals are forwarded through different communication links.

On the basis of any one of the foregoing exemplary embodiments, the second control circuit 42 may further include a power management circuit configured to control power supply for the gimbal 62 and the photographing device.

In an exemplary embodiment, the power management circuit may be configured to control power supply for the gimbal 62 and a camera, including switching of power supply, power control, status detection, and the like for different loads 60. In addition, the power management circuit may also control interlink and association of a plurality of loads 60.

The load control method provided in the foregoing exemplary embodiment includes: receiving a control instruction sent by a control device corresponding to the mobile platform, where the control instruction includes original identification information of a load; determining, based on the original identification information of the load, a target hardware port connected to the load; modifying, based on the target hardware port connected to the load, the original identification information of the load in the control instruction to target identification information identifiable by the target hardware port; and sending the modified control instruction to the load through the target hardware port. For a plurality of loads carried by the mobile platform, real-time, stable, and reliable switching and control can be implemented, and the scalability of the mobile platform is improved. If a device needs to be added at a hardware port or a hardware port needs to be directly added later on, only original identification information of a load and target identification information identifiable by the hardware port needs to be configured. Therefore, software changes may be reduced, an increase of the quantity of load does not cause instability or brings about limitations, and development and maintenance costs may be reduced.

In some exemplary embodiments, switching and control for different loads may be implemented not merely by using the hardware port in each of the foregoing exemplary embodiments; switching and control for different loads may also be implemented by using a virtual private protocol port, a user-defined network port, a VID (Vendor ID) in USB (Universal Serial BUS) hardware, and a PID (Product ID).

According to some exemplary embodiments of the present disclosure, there is also provided a mobile platform. FIG. 5 is a structural diagram of a mobile platform according to some exemplary embodiments some exemplary embodiments of the present disclosure. As shown in FIG. 5, the mobile platform 50 includes: a body 51; a power system 52 mounted in the body 51 and configured to supply power; a plurality of hardware ports 53, where the hardware ports 53 are configured to connect to loads 60; a communication interface 55 configured to communicate with a control device corresponding to the mobile platform; and one or more processors 54 configured to: receive, through the communication interface 55, a control instruction sent by the control device corresponding to the mobile platform 50, where the control instruction includes original identification information of a load 60; determine, based on the original identification information of the load 60, a target hardware port 53 connected to the load 60; modify the original identification information of the load 60 in the control instruction to target identification information identifiable by the target hardware port 53; and send the modified control instruction to the load 60 through the target hardware port 53.

On the basis of any one of the foregoing exemplary embodiments, the load 60 may include at least one of the following devices: a gimbal, a photographing device, and a gimbal electronic speed control.

On the basis of any one of the foregoing exemplary embodiments, the target hardware port 53 may be communicatively connected to each of the at least one device.

On the basis of any one of the foregoing exemplary embodiments, a link identification of a communication link between the target hardware port 53 and one device may be different from a link identification of a communication link between the target hardware port 53 and another device.

On the basis of any one of the foregoing exemplary embodiments, the devices of the same type may have the same target identification information.

On the basis of any one of the foregoing exemplary embodiments, the processor 54 may further be configured to: receive, through the target hardware port 53, data sent by the load 60, where the data includes the target identification information of the load 60; modify the target identification information of the load 60 in the data to the original identification information of the load 60; and send the modified data to the control device through the communication interface 55.

On the basis of any one of the foregoing exemplary embodiments, before receiving, through the communication interface 55, the control instruction sent by the control device corresponding to the mobile platform 50, the processor 54 may further be configured to: obtain type information of a load 60 connected to each hardware port 53 in the plurality of hardware ports 53; and send, to the control device through the communication interface 55, type information of the load 60 connected to the hardware port 53, so that the control device displays, based on the type information of the load 60, a user interface corresponding to the type information.

On the basis of any one of the foregoing exemplary embodiments, the original identification information of the load 60 may be used to identify the type information of the load 60.

On the basis of any one of the foregoing exemplary embodiments, the mobile platform 50 may include a first control circuit and a second control circuit, and the first control circuit may be communicatively connected to the second control circuit.

The first control circuit may be communicatively connected to the plurality of hardware ports 53, forming a first communication link.

The second control circuit may be communicatively connected to the photographing device, forming a second communication link.

When the second control circuit receives second data of the photographing device that is sent by the control device, the second control circuit may send the second data to the photographing device through the second communication link.

When the second control circuit receives first data of the gimbal that is sent by the control device, the second control circuit may send the first data to the gimbal through the first communication link.

On the basis of any one of the foregoing exemplary embodiments, the second communication link may be a USB interface communication link.

On the basis of any one of the foregoing exemplary embodiments, the second communication link may be configured to transmit at least one of the following data: image data and photographing device upgrade data.

On the basis of any one of the foregoing exemplary embodiments, the first communication link may be a serial port communication link.

On the basis of any one of the foregoing exemplary embodiments, the first communication link may be configured to transmit at least one of the following data: a control instruction and gimbal upgrade data.

On the basis of any one of the foregoing exemplary embodiments, the first control circuit may include a wireless communication circuit configured to establish a wireless communication connection to the control device of the mobile platform 50.

On the basis of any one of the foregoing exemplary embodiments, the second control circuit may include a routing circuit configured to forward communication signals.

On the basis of any one of the foregoing exemplary embodiments, the second control circuit may further include a power management circuit configured to control the power supply for the gimbal and the photographing device.

On the basis of any one of the foregoing exemplary embodiments, the mobile platform 50 may include an unmanned aerial vehicle.

Specific principles and implementations of the mobile platform provided in some exemplary embodiments some exemplary embodiments of the present disclosure are similar to those in the foregoing exemplary embodiment. Details are not described again herein.

The mobile platform provided in some exemplary embodiments some exemplary embodiments may receive a control instruction sent by a control device corresponding to the mobile platform, where the control instruction includes original identification information of a load; determine, based on the original identification information of the load, a target hardware port of the mobile platform connected to the load from the plurality of hardware ports; modify, based on the target hardware port connected to the load, the original identification information of the load in the control instruction to target identification information identifiable by the target hardware port; and send the modified control instruction to the load through the target hardware port. In some exemplary embodiments some exemplary embodiments of the present disclosure, for a plurality of loads carried by the mobile platform, real-time, stable, and reliable switching and control may be realized, and the scalability of the mobile platform is improved. If a device needs to be added at a hardware port or a hardware port needs to be directly added later on, only original identification information of a load and target identification information identifiable by the hardware port needs to be configured. Therefore, software changes may be reduced, an increase of the quantity of load does not cause instability or brings about limitations, and development and maintenance costs may be reduced.

In addition, the exemplary embodiments of the present disclosure may further provide a computer-readable storage medium, where the computer-readable storage medium stores a computer program, and the computer program is executed by a processor to implement the load control method in the foregoing exemplary embodiment.

In the several exemplary embodiments provided in the present disclosure, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware or may be implemented in a form of hardware in addition to a software functional unit.

When the foregoing integrated unit is implemented in the form of a software functional unit, the integrated unit may be stored in a computer-readable storage medium. The software functional unit is stored in a storage medium and includes several instructions for instructing a computer device (which may be a personal computer, a server, a network device, or the like) or a processor to perform a part of the steps of the methods described in the embodiments of the present disclosure. The foregoing storage medium includes any medium that can store program code, such as a USB flash drive, a removable hard disk, a read-only memory (ROM), a random-access memory (RAM), a magnetic disk, or an optical disc.

It may be clearly understood by persons skilled in the art that, for the purpose of convenient and brief description, division of the foregoing functional modules is used as an example for illustration. In actual application, the foregoing functions can be allocated to different functional modules and implemented according to a requirement, that is, an internal structure of the apparatus is divided into different functional modules to implement all or a part of the functions described above. For a detailed working process of the foregoing apparatus, reference may be made to a corresponding process in the foregoing method embodiments, and details are not described again herein.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A load control method for a mobile platform, comprising:
receiving, from a control device corresponding to the mobile platform, a control instruction including original identification information of a load;
determining, based on the original identification information, a target hardware port of the mobile platform connected to the load from a plurality of hardware ports of the mobile platform;
modifying, based on the target hardware port, the original identification information in the control instruction to target identification information identifiable by the target hardware port; and
sending the modified control instruction to the load through the target hardware port.

2. The method according to claim 1, wherein each of the plurality of hardware ports is compatible with a plurality of devices of different types, and the load includes at least one device of the plurality of devices.

3. The method according to claim 2, wherein the target hardware port is configured to communicatively connected to each of the plurality of devices, respectively.

4. The method according to claim 3, wherein a link identification of a communication link between the target hardware port and one device in the plurality of devices is different from a link identification of a communication link between the target hardware port and another device in the plurality of devices.

5. The method according to claim 2, wherein devices of a same type that are communicatively connected to the mobile platform have same target identification information.

6. The method according to claim 1, further comprising:
receiving data sent by the load, wherein the data includes the target identification information;
modifying the target identification information in the data to the original identification information; and
sending the modified data to the control device.

7. The method according to claim 1, further comprising, before the receiving of the control instruction:
obtaining type information of a load connected to each of the plurality of hardware ports; and
sending the type information to the control device, so that the control device displays, based on the type information, a user interface corresponding to the type information.

8. The method according to claim 7, wherein the original identification information identifies the type information.

9. The method according to claim 2, wherein the plurality of devices of different types include a gimbal and a photographing device,
the mobile platform includes a first control circuit and a second control circuit communicatively connected to the first control circuit;
the first control circuit is configured to communicatively connected to the plurality of hardware ports, forming a first communication link;
the second control circuit is configured to communicatively connected to the photographing device, forming a second communication link; and
the method further comprising:
when the second control circuit receives second data of the photographing device from the control device, sending, by the second control circuit, the second data to the photographing device through the second communication link; and
when the second control circuit receives first data of the gimbal from the control device, sending, by the second control circuit, the first data to the gimbal through the first communication link.

10. The method according to claim 9, wherein
the second communication link is a USB interface communication link;
the first communication link is a serial port communication link;
the second communication link is configured to transmit at least one of image data or photographing device upgrade data; and
the first communication link is configured to transmit at least one of a control instruction or gimbal upgrade data.

11. The method according to claim 9, wherein the second control circuit includes at least one of:
a wireless communication circuit configured for wireless communication connection to the control device of the mobile platform;
a routing circuit configured to forward communication signals; or
a power management circuit configured to control power supply for the gimbal and the photographing device.

12. The method according to claim 1, wherein the mobile platform includes an unmanned aerial vehicle.

13. A mobile platform, wherein comprising:
a body;
a power system, mounted in the body and configured to supply power;
a plurality of hardware ports, each of the plurality of hardware ports is configured to connect to a load;
a communication interface, configured to communicate with a control device corresponding to the mobile platform; and
one or more processors, configured to:
receive a control instruction from the control device through the communication interface, wherein the control instruction includes original identification information of a load;
determine, based on the original identification information, a target hardware port of the mobile platform connected to the load from the plurality of hardware ports;
modify the original identification information in the control instruction to target identification information identifiable by the target hardware port; and
send the modified control instruction to the load through the target hardware port.

14. The mobile platform according to claim 13, wherein each of the plurality of hardware ports is compatible with a plurality of devices of different types, and the load includes at least one device of the plurality of devices.

15. The mobile platform according to claim 14, wherein the target hardware port is configured to communicatively connected to each of the plurality of devices, respectively.

16. The mobile platform according to claim 15, wherein a link identification of a communication link between the target hardware port and one device in the plurality of devices is different from a link identification of a communication link between the target hardware port and another device in the plurality of devices.

17. The mobile platform according to claim 14, wherein devices of a same type that are communicatively connected to the mobile platform have same target identification information.

18. The mobile platform according to claim 13, wherein the one or more processors is further configured to:
receiving data sent by the load, wherein the data includes the target identification information;
modifying the target identification information in the data to the original identification information; and
sending the modified data to the control device.

19. The mobile platform according to claim 13, wherein the one or more processors is further configured to, before the receiving of the control instruction:
obtaining type information of a load connected to each of the plurality of hardware ports; and
sending the type information to the control device, so that the control device displays, based on the type information, a user interface corresponding to the type information.

20. The mobile platform according to claim 19, wherein the original identification information identifies the type information.
